(19) United States
(12) Patent Application Publication
(10) Pub. No.: US 2006/0039472 A1
(43) Pub. Date: Feb. 23, 2006

(54) Methods and apparatus for coding of motion vectors

(76) Inventors: Joeri Barbarien, Itegem (BE); Adrian Munteanu, Elsene (BE); Peter Schelkens, Willebrock (BE); Ioannis Andreopoulos, Los Angeles, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/147,419

(22) Filed: Jun. 6, 2005

Related U.S. Application Data
(63) Continuation of application No. PCT/BE03/00210, filed on Dec. 4, 2003.

(30) Foreign Application Priority Data
Dec. 4, 2002 (GB) 0228281.2

(51) Int. Cl. H04N 11/02; H04N 11/04; H04B 1/66; H04N 7/12

(52) U.S. Cl. 375/240.16; 375/240.03; 375/240.23; 375/240.19

(57) ABSTRACT

A method and apparatus is described for coding motion information in video processing of a stream of image frames and for avoiding the drift problem. The method or apparatus is for providing motion vectors of at least one image frame, and for coding the motion vectors to generate a quality-scalable representation of the motion vectors. The quality-scalable representation of motion vectors can comprise a set of base-layer motion vectors and a set of one or more enhancement-layers of motion vectors. The method of decoding and a decoder for such coded motion vectors as part of receiving and processing a bit stream at a receiver includes the base-layer of motion vectors being losslessly decoded, while the one or more enhancement layers of motion vectors are progressively received and decoded, optionally including progressive refinement of the motion vectors, eventually up to their lossless reconstruction.

### RELATED APPLICATIONS

This application is a continuation under 35 U.S.C. § 120 of PCT/BE2003/000210, entitled “METHODS AND APPARATUS FOR CODING OF MOTION VECTORS”, filed on Dec. 4, 2003, which was published in English, which is incorporated herein by reference.

### FIELD OF THE INVENTION

The invention relates to methods and apparatus and systems for coding framed data especially methods, apparatus and systems for video coding, in particular those exploiting subband transforms, in particular wavelet transforms. In particular the invention relates to methods and apparatus and systems for motion vector coding of a sequence of frames of framed data, especially methods, apparatus and systems for motion vector coding of video sequences, in particular those exploiting subband transforms, in particular wavelet transforms.

### BACKGROUND OF THE INVENTION

Video codecs are summarised in the book “Video coding” by M. Ghanbari, IEE press 1999. A basic method of compressing video images and thus to reduce the bandwidth required to transmit them is to work with differences between images or blocks of images rather than with the complete images themselves. The received image is then constructed by assembling later images from a complete initial image modified by error information for each image. This can be extended to determining motion of parts of the image—the motion can be represented by motion vectors. By making use of the error and motion vector information, each frame of the received image can be reconstructed. The concept of scalability is introduced in section 7.5 of the above book. Ideally the transmitted bit stream is so organised that a video of preferred quality can be selected by selecting a part of the bit stream. This may be achieved by a hierarchical bit stream, that is a bit stream in which the data required for each level of quality can be isolated from other levels of quality. This provides network scalability, i.e. the ability of a node of a network to select the quality level of choice by simply selecting a part of the bit stream. This avoids the need to decode and re-encode the bit-stream. Such a hierarchically organised bit stream may include a “base layer” and “enhanced layers”, wherein the base layer contains the data for one quality level and the enhanced layer includes the residual information necessary to enhance the quality of the received image. Preferably, the type of scalablity, e.g. spatial or temporal can be selected independently of each other, i.e. different types of scalability are supported by the same data stream—this is called hybrid scalabity.

Certain transforms have been used to assist in video compression, e.g. the discrete wavelet transform (DWT), see for example: “Wavelets and Subbands”, A. Abbate et al., Birkhäuser, 2002. Wavelet video codecs based on spatial-domain MCTF (SDMCTF) are presented in D. S. Turaga and M. v d Schaar, “Unconstrained motion compensated temporal filtering,” ISO/IEC JTC1/SC29/WG11, m8388, MPEG meeting, Fairfax, USA, May 2002, B. Pesquet-Popescu and V. Bottreau, “Three-dimensional lifting schemes for motion compensated video compression,” Proc. IEEE ICASSP, Salt Lake City, Utah, May 7-11, vol. 3, pp. 1793-1796, 2001, J. -R. Ohm, “Complexity and Delay Analysis of MCTF Interframe Wavelet Structures,” ISO/IEC JTC1/SC29/WG11, m8520, MPEG-meeting Klagenfurt, July 2002, and Y. Zhan, M. Picard, B. Pesquet-Popescu and H. Heijmans, “Long temporal filters in lifting schemes for scalable video coding,” ISO/IEC JTC1/SC29/WG11, m8680, MPEG meeting, Klagenfurt, July 2002. In these schemes, the motion estimation and compensation (ME/MC) are performed in the spatial domain. Afterwards, the prediction errors are wavelet transformed and the transform coefficients are entropy coded.

It is also possible to perform the motion compensation and estimation in the transformed domain. Coding of the transformed image is called in-band coding. Because the motion estimation is performed in the wavelet domain, each resolution level has a set of motion vectors associated to it. This may have the disadvantage that the number of motion vectors increases because of the increased number of levels of representation. The final bit stream, which is a combination of error images and motion vectors, then requires more bandwidth. Ideally, to avoid a performance penalty when decoding to lower resolutions, only the motion vector data associated with the transmitted resolution levels should be sent. Hence, the system used to encode the motion vector data has to take this into account and has to produce a resolution scalable bit-stream.

### SUMMARY OF CERTAIN INVENTIVE ASPECTS

The present invention provides in one aspect a method of coding motion information in video processing of a stream of image frames, comprising:

providing motion vectors for at least one image frame,

quantizing the motion vectors to generate a set of quantized motion vectors equivalent to the motion vectors,

compressing the quantized motion vectors losslessly,

generating error vectors, each error vector being a difference between a motion vector and its quantized equivalent, and

progressively encoding the error vectors in a lossy-to-lossless manner.

The present invention also provides in another aspect a method of decoding encoded motion vectors in a bitstream received at a receiver and coded by the above method, the decoding method comprising progressively decoding the error vectors in a lossy-to-lossless manner.

The present invention also provides in another aspect a method of providing a representation of motion information in video processing of a stream of image frames, comprising:

providing in-band motion vectors of at least one image frame,

converting the in-band motion vectors to a spatial domain to generate motion vectors equivalent to the in-band motion vectors,

non-linearly predicting prediction motion vectors from spatial correlation of neighbouring motion vectors in one image frame,

generating prediction-error vectors from differences between the motion vectors in the spatial domain and the prediction motion vectors,

coding the prediction error vectors, and

outputting the coded prediction-error vectors.

The present invention also provides in another aspect a method of decoding encoded motion vectors in a bitstream received at a receiver having been encoded by the above method, the decoding method comprising progressively decoding the coded prediction error vectors.

The present invention provides in another aspect a method of providing a representation of motion information in video processing of a stream of image frames, comprising:

providing in-band motion vectors of at least one image frame,

converting the in-band motion vectors to a spatial domain to generate motion vectors equivalent to the in-band motion vectors,

transforming the motion vectors in the spatial domain to a wavelet domain using an integer wavelet transform to generate wavelet coefficients, and

coding the wavelet coefficients.

The present invention also provides in another aspect a method of decoding a bitstream received at a receiver which has been coded by the above method, the decoding method comprising decoding the wavelet coefficients and generating the motion vectors.

The present invention provides in another aspect a method of coding motion vectors of at least one image frame in video processing of a stream of image frames, comprising:

transforming the motion vectors using the integer wavelet transform to generate wavelet coefficients, and

coding the wavelet coefficients.

The present invention provides in another aspect a method of decoding a bitstream received at a receiver which has been coded by the above method, the decoding method comprising decoding the wavelet coefficients and generating motion vectors from the decoded wavelet coefficients.

The present invention provides in another aspect a method of coding motion information in video processing of a stream of image frames, comprising:

providing motion vectors of at least one image frame, and

coding of the motion vectors to generate a quality-scalable representation of the motion vectors.

The present invention also provides in another aspect a method of decoding a bitstream received at a receiver which has been coded by the above method, the decoding method comprising decoding a base layer of motion vectors and an enhancement layer of motion vectors and enhancing a quality of a decoded image by improving the quality of the base layer of motion vectors using the enhancement layer of motion vectors.

The present invention also provides in another aspect an encoder for coding motion information in video processing of a stream of image frames, comprising:

means for providing motion vectors for at least one image frame,

means for quantizing the motion vectors to generate a set of quantized motion vectors equivalent to the motion vectors,

means for compressing the quantized motion vectors losslessly,

means for generating error vectors, each error vector being a difference between a motion vector and its quantized equivalent, and

means for progressively encoding the error vectors in a lossy-to-lossless manner.

The present invention also provides in another aspect a device for providing a representation of motion information in video processing of a stream of image frames, comprising:

means for providing in-band motion vectors of at least one image frame,

means for converting the in-band motion vectors to a spatial domain to generate motion vectors equivalent to the in-band motion vectors,

means for non-linearly predicting prediction motion vectors from spatial correlation of neighbouring motion vectors in one image frame,

means for generating prediction-error vectors from differences between the motion vectors in the spatial domain and the prediction motion vectors,

means for coding the prediction error vectors, and

means for outputting the coded prediction-error vectors.

Th present invention also provides in another aspect a device for providing a representation of motion information in video processing of a stream of image frames, comprising:

means for providing in-band motion vectors of at least one image frame,

means for converting the in-band motion vectors to a spatial domain to generate motion vectors equivalent to the in-band motion vectors,

means for transforming the motion vectors in the spatial domain to a wavelet domain using an integer wavelet transform to generate wavelet coefficients, and

means for coding the wavelet coefficients.

The present invention also provides in another aspect an encoder for coding motion vectors of at least one image frame in video processing of a stream of image frames, comprising:

means for transforming the motion vectors using the integer wavelet transform to generate wavelet coefficients, and

means for coding the wavelet coefficients.

The present invention also provides in another aspect an encoder for coding motion information in video processing of a stream of image frames, comprising:

means for providing motion vectors of at least one image frame, and

means for coding of the motion vectors to generate a quality-scalable representation of the motion vectors.

The present invention also provides in another aspect a decoder for all of the encoders above.

The present invention also provides in another aspect computer program product which when executed on a processing device executes any of the methods of the present invention.

The present invention also provides in another aspect a machine readable data carrier storing the computer program product.

### BRIEF DESCRIPTION OF THE DRAWINGS

FIGS. 1a-c show general setups of coders for spatial (FIG. 1a), in-band (FIG. 1b) and hybrid (FIG. 1c) video codecs using either spatial or in-band motion estimation or in-band motion estimation based on the CODWT.

FIG. 2 shows per-level in-band motion estimation and compensation in accordance with an embodiment of the present invention.

FIG. 3 shows a layout of the motion vector set produced by in-band motion estimation in accordance with an embodiment of the present invention.

FIGS. 4a, b show flow diagrams of motion vector coding techniques in accordance with embodiments of the present invention.

FIG. 5 shows neighboring motion vectors involved in the prediction in accordance with an embodiment of the present invention.

FIG. 6 shows motion vectors used to predict in prediction scheme 2 in accordance with an embodiment of the present invention.

FIG. 7 shows prediction scheme 3 in accordance with an embodiment of the present invention.

FIG. 8 shows prediction scheme 4 in accordance with an embodiment of the present invention.

FIG. 9 shows examples of the two sets of flags transmitted by the prediction-error coder 3 in accordance with an embodiment of the present invention.

FIG. 10 shows a 3D structure assembled in prediction error coder 5 in accordance with an embodiment of the present invention.

FIG. 11 shows a structure of the motion vector set in accordance with an embodiment of the present invention.

FIG. 12a shows a coder in accordance with a further embodiment of the present invention.

FIG. 12b shows a flow diagram of motion vector coding techniques in accordance with a further embodiment of the present invention.

FIG. 13 shows a schematic representation of a telecommunications system to which any of the embodiments of the present invention may be applied.

FIG. 14 shows a circuit suitable for motion vector coding or decoding in accordance with any of the embodiments of the present invention.

FIG. 15 shows a further circuit suitable for motion vector coding or decoding in accordance with any of the embodiments of the present invention.

### DEFINITIONS

Drift-free refers to the fact that both the encoder and decoder use only information that is commonly available to both the encoder and the decoder for any target bit-rate or compression ratio. With non-drift-free algorithms the decoding errors will propagate and increase with time so that quality of the decoded video decreases.

Resolution scalability refers to the ability to decode the input bit stream of an image at different resolutions at the receiver.

Resolution scalable decoding of the motion vectors refers to the capability of decoding different resolutions by only decoding selected parts of the input coded motion vector field. Motion vector fields generated by an in-band video coding architecture are coded in a resolution-scalable manner.

Temporal scalability refers to the ability to change the frame rate to number of frames ratio in a bit stream of framed digital data.

Quality of motion vectors is defined as the accuracy of the motion vectors, i.e. how closely they represent the real motion of part of an image.

Quality scalable motion vectors refers to the ability to progressively degrade quality of the motion vectors by only decoding a part of the input coded stream to the receiver.

“Lossy to lossless” refers to graceful degradation and scalability, implemented in progressive transmission schemes. These deal with situations wherein when transmitting image information over a communication channel, the sender is often not aware of the properties of the output devices such as display size and resolution, and the present requirements of the user, for example when he is browsing through a large image database. To support the large spectrum of image and display sizes and resolutions, the coded bit stream is formatted in such a way that whenever the user or the receiving device interrupts the bit stream, a maximal display quality is achieved for the given bit rate. The progressive transmission paradigm incorporates that the data stream should be interruptible at any stage and still deliver at each breakpoint a good trade-off between reconstruction quality and compression ratio. An interrupted stream will still enable image reconstruction, though not a complete one, which is denoted as a “lossy” approach, since there is loss of information. When the full stream is received a complete reconstruction is possible, hence this is called a “lossless” approach, since no information is lost.

Quantization: at the sender or transmitter side of a transmission system, or at any intermediate part or node of the system where quantization is required, a source digital signal S, such as e.g. a source video signal (an image), or more generally any type of input data to be transmitted, is quantized in a quantizer, or in a plurality of quantizers so as to form a number of N bit-streams S₁, S₂, . . . , S_{N}. The source signal can be a function of one or more continuous or discrete variables, and can itself be continuous or discrete-valued. The generation of bits from a continuous-valued source inevitably involves some form of quantization, which is simply an approximation of a quantity with an element chosen from a discrete set. Each of the generated N bit-streams S₁, S₂, . . . , S_{N} may or may not be encoded subsequently, for example, entropy encoded, in encoders C₁, C₂, . . . , C_{N} before transmitting them over a channel. Quantisation when referred to motion vectors includes setting lengths of motion vector axes (2 for 2D, 3 for 3D) in accordance with an algorithm which chooses between a zero value or a unitary value for each scalar value of the axes of a motion vector. For example, each scalar value of a vector on an axis is compared with a set value, if the scalar value is less than this value, a zero value is assigned for this axis, and if the scalar value is greater than this value a unitary value is assigned.

### DETAILED DESCRIPTION OF CERTAIN INVENTIVE EMBODIMENTS

The present invention provides methods and apparatus to compress motion vectors generated by spatial or in-band motion estimation. Spatial or in-band encoders or decoders according to the present invention can be can be divided into two groups. The first group makes use of algorithms based on motion-vector prediction and prediction-error coding. The second group is based on the integer wavelet transform. The performance of the coding schemes on motion vector sets generated by encoding have been investigated at 3 different sequences at 3 different quality-levels. The experiments show that the encoders/decoders based on motion-vector prediction yield better results than the encoders/decoders based upon the integer wavelet transform. The results indicate that the correlation between the motion vectors seems to degrade as the quality of the decoded images decreases. The encoders/decoders that give the best performance are those based upon either spatio-temporal prediction or spatio-temporal and cross-subband prediction combined with a prediction-error coder. This prediction-error coder codes the prediction errors similarly to the way the DCT coefficients are coded in the JPEG standard for still-image compression.

In a first aspect of the invention the invention discloses an in-band MCTF scheme (IBMCTF), wherein first the overcomplete wavelet decomposition is performed, followed by temporal filtering in the wavelet domain.

A side effect of performing the motion estimation in the wavelet domain is that the number of motion vectors produced is higher than the number of vectors produced by spatial domain motion estimation operating with equivalent parameters. Efficient compression of these motion vectors is therefore an important issue.

In a second aspect of the invention a number of motion vector coding techniques are presented that are designed to code motion vector data generated by a video codec based on in-band motion estimation and compensation.

In an embodiment thereof prediction schemes, using cross subband correlations between motion vectors are exploited.

In an alternative embodiment thereof the use of a table for registration of the most frequently appearing motion vectors for reducing the amount of to code symbols is disclosed.

In a further aspect thereof combinations of these motion vector coding techniques is disclosed, in particular the combination of entropy coder 3 with entropy coder 2.

The motion vector coding techniques are useful for both the classical “hybrid structure” for video coding, and involves in-band ME/MC as the alternative video codec architecture involving in-band ME/MC and MCTF.

A generic aspect of the motion vector coding techniques is applying a step of classifying the motion vectors before performing a class refining step.

In a further aspect of the present invention quality-scalable motion vector coding is used to provide scalable wavelet-based video codecs over a large range of bit-rates. In particular, the present invention includes a motion vector coding technique based on the integer wavelet transform. This scheme allows for reducing the bit-rate spent on the motion vectors. The motion vector field is compressed by performing an integer wavelet transform followed by coding of the transform coefficients using the quad tree coder (e.g. the QT-L coder of P. Schelkens, A. Munteanu, J. Barbarien, M. Galca, X. Giro i Nieto, and J. Cornelis, “Wavelet Coding of Volumetric Medical Datasets,” IEEE Transactions on Medical Imaging, Special issue on “Wavelets in Medical Imaging,” Editors M. Unser, A. Aldroubi, and A. Laine, vol. 22, no. 3, pp. 441-458, March 2003 which is incorporated herewith by reference). In a further aspect of the present invention efficiency of a motion vector coder (MVC) scheme for video processing is improved still further by prediction-based motion vector coder. Embodiments of the present invention combine the compression efficiency of prediction-based MVCs with quality scalability.

One aspect of the present invention is a combination of non-linear prediction, e.g. median-based prediction with quality scalable coding of the prediction errors. For example, the prediction motion vector errors generated by median-based prediction are coded using the QT-L codec mentioned above. However, a drift phenomenon caused by the closed-loop nature of the prediction may result. This means that errors that are successively produced by the quality scalable decoding of the prediction motion vector errors can cascade in such a way that a severely degraded motion vector set is decoded. The following table illustrates this drift effect in a simplified case where the prediction is performed on a ID dataset for simplicity's sake and each value is predicted by its predecessor. It is preferred to avoid drift.

| | | | | | | | | | | | | |
|---|---|---|---|---|---|---|---|---|---|---|---|---|
| Original values | 1 | 2 | −4 | −3 | −3 | 0 | 4 | 5 | 0 | 1 | 5 | −3 |
| Prediction | 1 | 1 | −6 | 1 | 0 | 3 | 4 | 1 | −5 | 1 | 4 | −8 |
| error (lossless) | | | | | | | | | | | | |
| Prediction | 0 | 0 | −6 | 0 | 0 | 2 | 4 | 0 | −4 | 0 | 4 | −8 |
| error (lossy) | | | | | | | | | | | | |
| Decoded | 0 | 0 | −6 | −6 | −6 | −4 | 0 | 0 | −4 | −4 | 0 | −8 |
| values | | | | | | | | | | | | |
| Decoding error | −1 | −2 | −2 | −3 | −3 | −4 | −4 | −5 | −4 | −5 | −5 | −5 |

In a further aspect of the present invention a method and apparatus which includes coding motion information in video processing of a stream of image frames is described for avoiding the drift problem. The method or apparatus is for providing motion vectors of at least one image frame, and for coding the motion vectors to generate a quality-scalable representation of the motion vectors. The quality-scalable representation of motion vectors comprises a set of base-layer motion vectors and a set of one or more enhancement-layers of motion vectors. The method of decoding and a decoder for such coded motion vectors as part of receiving and processing a bit stream at a receiver includes the base-layer of motion vectors being losslessly decoded, while the one or more enhancement layers of motion vectors are progressively received and decoded, optionally including progressive refinement of the motion vectors, eventually up to their lossless reconstruction. This embodiment ensures that the motion vectors are progressively refined at the receiver in a lossy-to-lossless manner as the base-layer of motion vectors is losslessly decoded, while the one or more enhancement layers of motion vectors are progressively received and decoded.

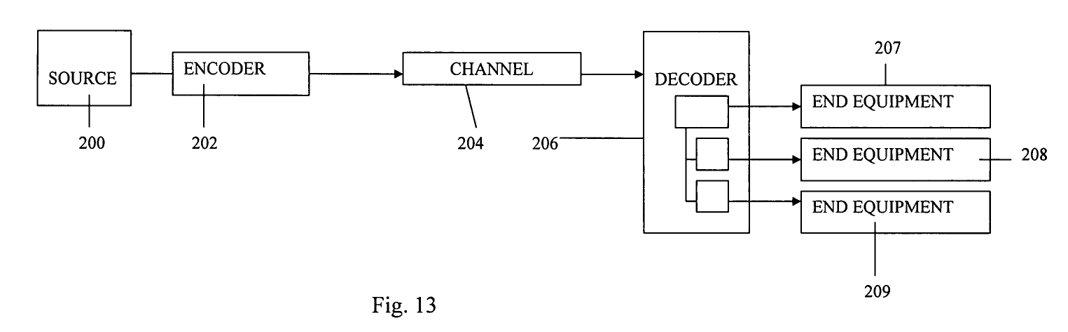

An example of a communication system 210 which can be used with the present invention is shown in FIG. 13. It comprises a source 200 of information, e.g. a source of video signals such as a video camera or retrieval from a memory. The signals are encoded in an encoder 202 resulting in a bit stream, e.g. a serial bit stream which is transmitted through a channel 204, e.g. a cable network, a wireless network, an air interface, a public telephone network, a microwave link, a satellite link. The encoder 202 forms part of a transmitter or transceiver if both transmit and receive functions are provided. The received bit stream is then decoded in a decoder 206 which is part of a receiver or transceiver. The decoding of the signal may provide at least one of spatial scalablity, e.g. different resolutions of a video image are supplied to different end user equipments 207-209 such as video displays; temporal scalability, e.g. decoded signals with different frame rate/frame number ratios are supplied to different user equipments; and quality scalability, e.g. decoded signals with different signal to noise ratios are supplied to different user equipments.

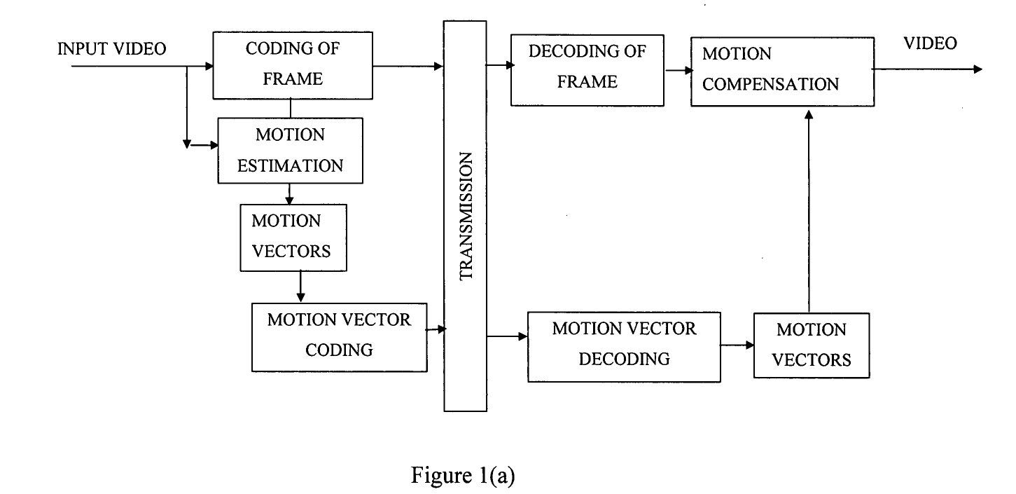

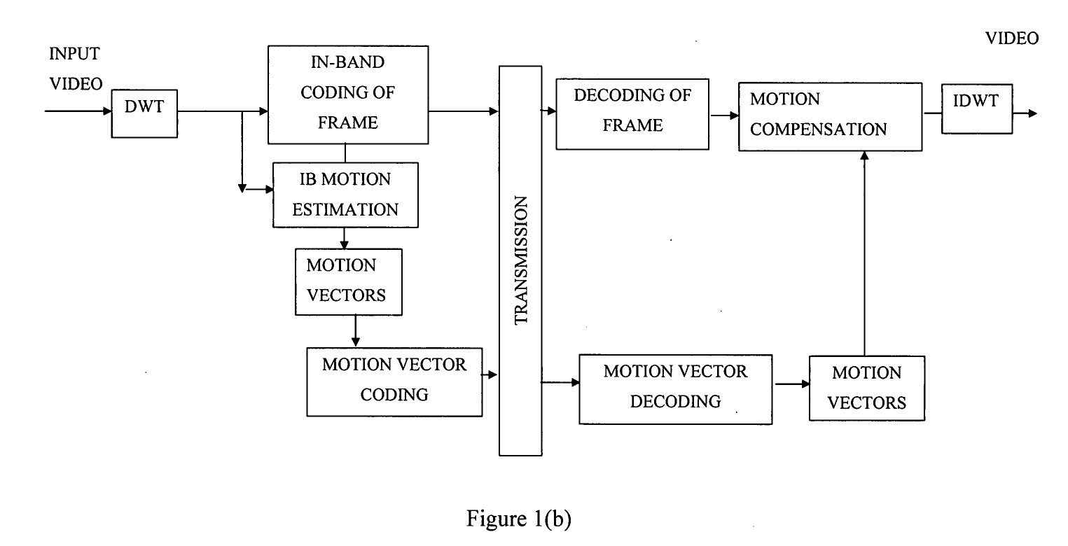

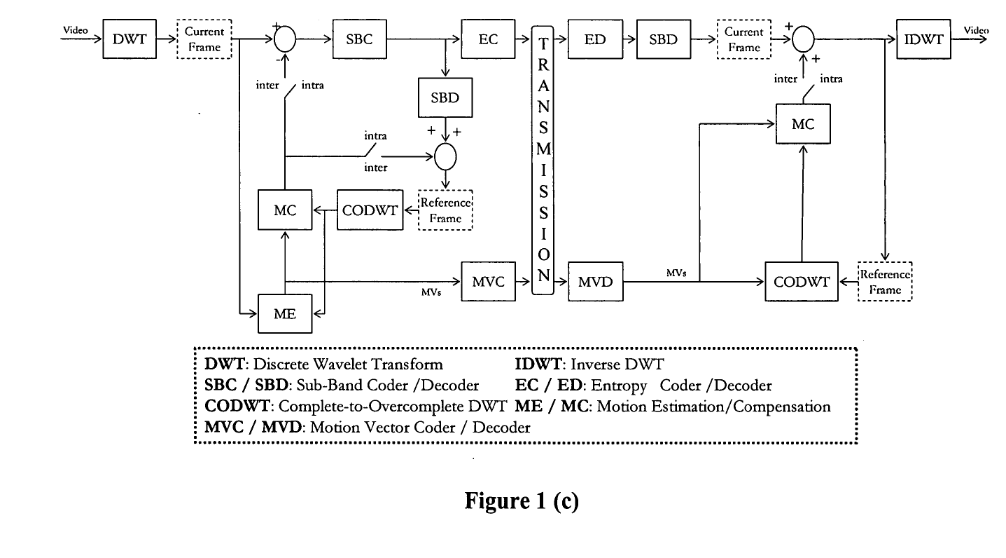

Several motion vector (MV) coding techniques are included within the scope of the present invention to compress motion vector sets. The techniques can be classified into at least two basic groups based on whether they use in-band (FIG. 1b) or spatial motion vectors (FIG. 1a) as their input. In each case frames of framed data such as a sequence of video frames are coded and motion estimation is carried out to obtain motion vectors. These motion vectors are compressed and transmitted with the bit stream. In the decoder the fame data and the motion vectors are decoded and the video reconstructed using the motion vectors in motion compensation of the decoded frame data.

A Video Codec Based on Spatial or In-band Motion Estimation using the Complete-to-Overcomplete Discrete Wavelet Transform

A first embodiment of the present invention relates to a video codec which follows a classical “hybrid structure” for video coding, and involves, in one aspect, in-band ME/MC. Alternatively, the same techniques may be applied coding of spatial motion vectors.

An alternative video codec architecture involving in-band ME/MC and MCTF is described in Y. Andreopoulos, M. van der Schaar, A. Munteanu, J. Barbarien, P. Schelkens, and J. Cornelis, “Open-loop, in-band, motion-compensated temporal filtering for objective full-scalability in wavelet video coding,” ISO/IEC, incorporated by reference. Performing motion estimation directly between corresponding subbands of the wavelet transformed frames produces undesirable prediction results due to the shift-variance problem. Several solutions for this problem have been suggested in literature G. Van der Auwera, A. Munteanu, P. Schelkens, and J. Cornelis, “Bottom-up motion compensated prediction in the wavelet domain for spatially scalable video coding,” IEE Electronics Letters, vol. 38, no. 21, pp. 1251-1253, October 2002, X. Li, L. Kerofski and S. Lei, “All-phase motion compensated prediction in the wavelet domain for high performance video coding,” in Proc. IEEE Int. Conf. Image Processing (ICIP2001), Thessaloniki, Greece, 2001, vol. 3, pp. 538-541, and F. Verdichio, I. Andreopoulos, A. Munteanu, J. Barbarien, P. Schelkens, J. Cornelis, and A. Pepino, “Scalable video coding with in-band prediction in the complex wavelet transform,” Proceedings of Advanced Concepts for Intelligent Vision Systems (ACIVS2002), Gent, Belgium, pp. 6, Sep. 9-11, 2002.

A video codec according to an embodiment of the present embodiment is based on the complete-to-overcomplete discrete wavelet transform (CODWT). This transform provides a solution to overcome the shift-variance problem of the discrete wavelet transform (DWT) while still producing critically sampled error-frames is the low-band shift method (LBS) introduced theoretically in H. Sari-Sarraf and D. Brzakovic, “A Shift-Invariant Discrete Wavelet Transform,” IEEE Trans. Signal Proc., vol. 45, no. 10, pp. 2621-2626, October 1997 and used for in-band ME/MC in H. W. Park and H. S. Kim, “Motion estimation using Low-Band-Shift method for wavelet-based moving-picture coding,” IEEE Trans. Image Proc., vol. 9, no. 4, pp. 577-587, April 2000. First, this algorithm reconstructs spatially each reference frame by performing the inverse DWT. Subsequently, the LBS method is employed to produce the corresponding overcomplete wavelet representation, which is further used to perform in-band ME and MC, since this representation is shift invariant. Basically, the overcomplete wavelet decomposition is produced for each reference frame by performing the “classical” DWT followed by a unit shift of the low-frequency subband of every level and an additional decomposition of the shifted subband. Hence, the LBS method effectively retains separately the even and odd polyphase components of the undecimated wavelet decomposition—see G. Strang and T. Nguyen, Wavelets and Filter Banks. Wellesley-Cambridge Press, 1996. The “classical” DWT (i.e. the critically-sampled transform) can be seen as only a subset of this overcomplete pyramid that corresponds to a zero shift of each produced low-frequency subband, or conversely to the even-polyphase components of each level's undecimated decomposition. An improved form of the complete-to-overcomplete transform is described in US 2003 0133500 which is incorporated herein by reference in its entirety. This latter U.S. patent publication describes a method of digital encoding or decoding a digital bit stream, the bit stream comprising a representation of a sequence of n-dimensional data structures. The method is of the type which derives at least one further subband of an overcomplete representation from a complete subband transform of the data structures, and comprises providing a set of one or more critically subsampled subbands forming a transform of one data structure of the sequence; applying at least one digital filter to at least a part of the set of critically subsampled subbands of the data structure to generate a further set of one or more further subbands of a set of subbands of an overcomplete representation of the data structure, wherein the digital filtering step includes calculating at least a further subband of the overcomplete set of subbands at single rate.

Using the CODWT transform, the overcomplete discrete wavelet transform (ODWT) of a frame can be constructed in a level-by-level manner starting from the critically-sampled wavelet representation of that frame—see G. Van der Auwera, A. Munteanu, P. Schelkens, and J. Cornelis, “Bottom-up motion compensated prediction in the wavelet domain for spatially scalable video coding,” IEE Electronics Letters, vol. 38, no. 21, pp. 1251-1253, October 2002. The shift-variance problem does not occur when performing motion estimation between the critically-sampled wavelet transform of the current frame and the ODWT of the reference frame, because the ODWT is a shift-invariant transform. The general setup of an in-band video codec based on the CODWT is shown in FIG. 1c.

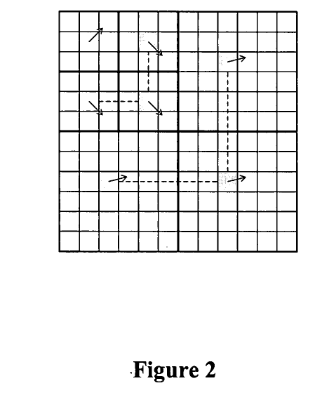

A particular example of this embodiment will now be presented but the motion vector coding techniques of the present invention is not limited thereto. For instance the present invention includes within its scope determining per detail subband motion vectors. In accordance with this example, the in-band motion estimation is performed on a per-level basis. For the highest decomposition level, block-based motion estimation and compensation is performed independently on the LL subband. The motion estimation for the LH, HL and HH subbands is not performed independently. Instead, only one vector is derived for each set of three blocks located at corresponding positions in the three subbands. This vector minimizes the mean square error (MSE) of the three blocks together. The LH, HL and HH subbands at lower levels can be handled identically. The intra-frames and error-frames are then further encoded. Every frame is predicted with respect to another frame of the video sequence, e.g. a previous frame or the previous frame as the reference, but the present invention is not limited to either selecting a previous frame a further frame. Also, the block size for the ME/MC is set to 8 pixels, regardless of the decomposition level. The search range is dyadically decreased with each level, starting at [−8, 7] for the first level. FIG. 2 exemplifies the motion estimation setup for two decomposition levels.

Motion Vector Coding

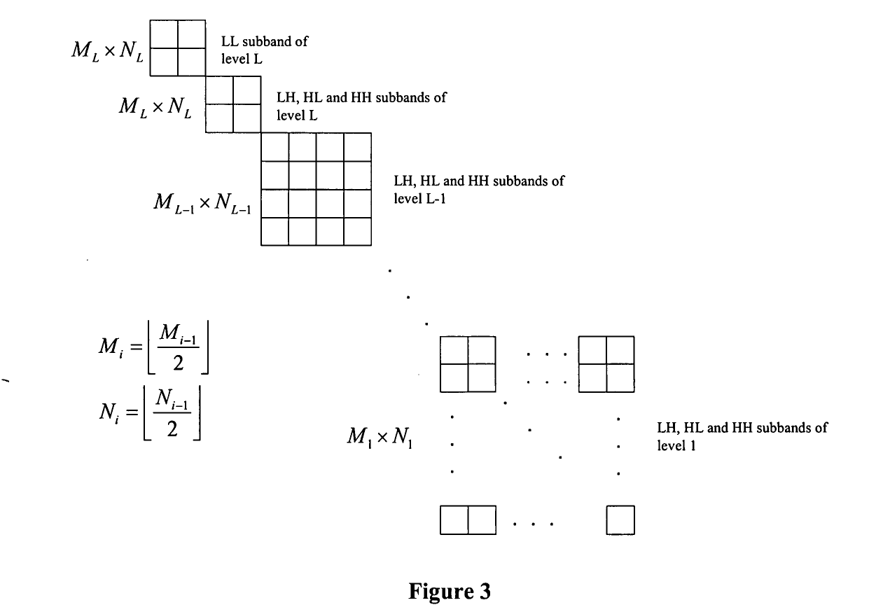

The structure of the set of motion vectors produced by the described in-band motion estimation technique for a wavelet decomposition with L levels is shown in FIG. 3.

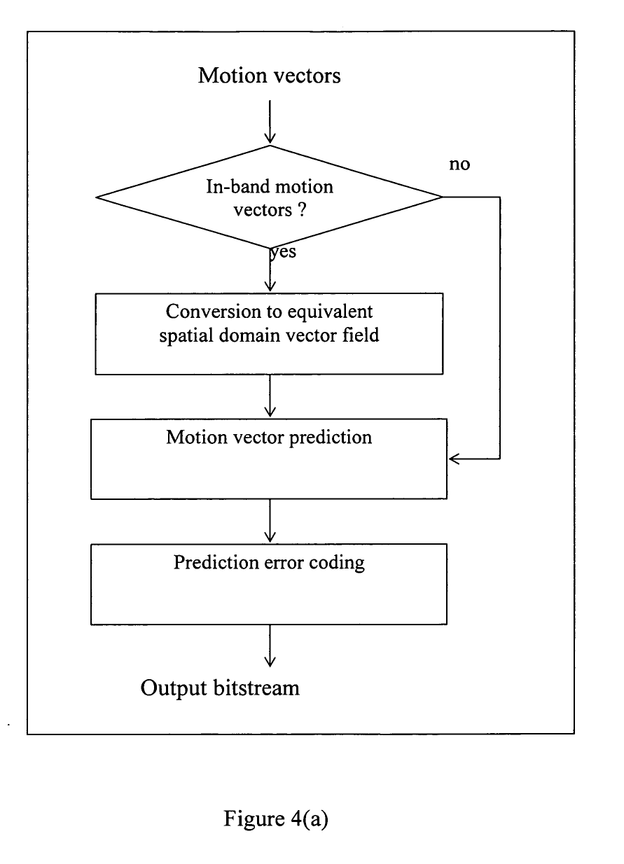

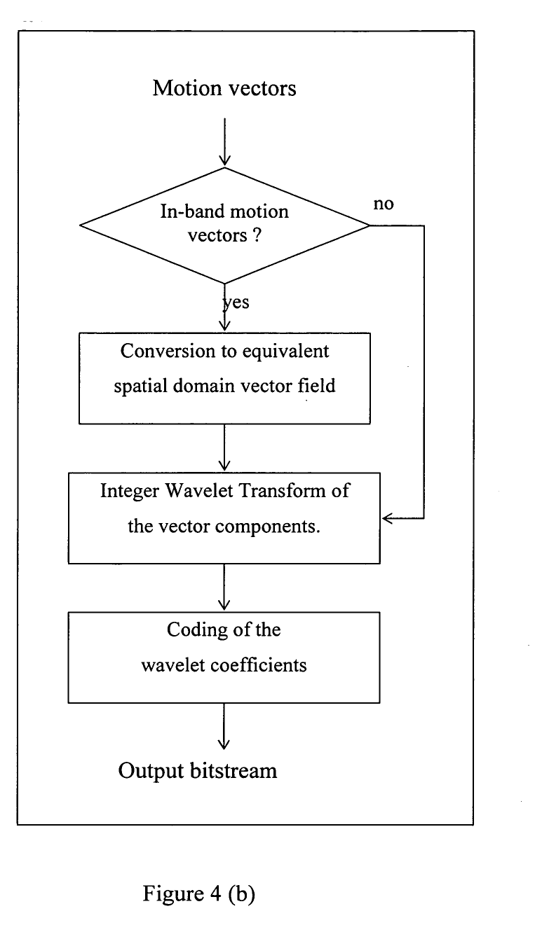

Several motion vector (MV) coding techniques are presented to compress motion vector sets of this type all of which are included within the scope of the present invention. The techniques can be classified into at least two groups based on their architecture. The first group of MV coders converts the in-band motion vectors to their equivalent spatial domain vectors and then performs motion vector prediction followed by prediction error coding. A common generic architecture for this group of coders is presented in FIG. 4(a). In the following coders and decoders which use in-band coding of the motion vectors will be described but the techniques apply to spatially coded motion vectors as well. As indicated in FIG. 4(a) if the input is spatial motion vectors which have been estimated in the spatial domain by spatial motion estimation, then these vectors progress immediately to motion vector prediction and prediction error coding.

In a second type of MV coders, the in-band motion vectors are first converted to their spatial domain equivalents. Afterwards, the components of the equivalent spatial domain vectors are wavelet transformed and the wavelet coefficients are coded. A common architecture for this type of MV coders is shown in FIG. 4(b). In the following coders and decoders which use in-band coding of the motion vectors will be described but the techniques apply to spatially coded motion vectors as well. As indicated in FIG. 4(b) if the input is spatial motion vectors which have been estimated in the spatial domain by spatial motion estimation, then these vectors go immediately to the Integer Wavelet transform step followed by coding of the wavelet coefficients.

For all the embodiments of the present invention, where coding is described the present invention also includes decoding by the inverse process to obtain the motion vectors followed by motion compensation of the decoded frame data using the retrieved motion vectors.

For both types of coders, the first step is the conversion of the in-band motion vectors to their equivalent spatial domain motion vectors. The motion vectors generated by in-band motion estimation consist of a pair of numbers (i,j) indicating the horizontal and vertical phase of the ODWT subband where the best match was found, and a pair of numbers (x,y) representing the actual horizontal and vertical offset of the best matching block within the indicated subband. From this data, an equivalent spatial domain motion vector (xₛₚₐₜᵢₐₗ, yₛₚₐₜᵢₐₗ) can be derived for each block using the following formulas:
xₛₚₐₜᵢₐₗ=((2·pel)^{level}·x+i)
yₛₚₐₜᵢₐₗ=((2·pel)^{level}·y+i)
For more explanation of these formulas see J. Barbarien, I. Andreopoulos, A. Munteanu, P. Schelkens, and J. Cornelis, “Coding of motion vectors produced by wavelet-domain motion estimation,” ISO/IEC JTC1/SC29/WG11 (MPEG), Awaji island, Japan, m9249, December 2002. In these formulas, pel indicates the accuracy of the motion estimation (pel=1 for integer-pel accuracy, pel=2 for half-pel accuracy and pel=4 for quarter-pel accuracy) and level indicates the wavelet decomposition level associated with the in-band motion vector.

The conversion to the equivalent spatial domain vectors is made to simplify the prediction or wavelet transformation that follows it.

The following notations are introduced to facilitate the following description:

L: The number of levels in the wavelet decomposition of the frames.

mvₜₒₜ (i): The complete set of equivalent spatial domain motion vectors generated by in-band motion estimation between frame i and i−1.

mv_{A} (i): The set of equivalent spatial domain motion vectors generated by performing motion estimation between the LL subbands of frames i and i−1. This is a subset of mvₜₒₜ (i).

mvⁿ_{D} (i): The set of equivalent spatial domain motion vectors generated by performing motion estimation between the LH, HL and HH subbands of level n of frame i and i−1. This is a subset of mvₜₒₜ (i).
It is clear that

$${mv}_{tot} ( i ) = {mv}_{A} ( i ) ⋃ ( {⋃}_{k = 1}^{k = L} {mv}_{D}^{k} ( i ) ) .$$

Motion vector coders based on motion-vector prediction and prediction-error coding

An embodiment of an MV coding scheme based on motion vector prediction and prediction error coding will be described with reference to FIG. 4(a). Four different motion vector prediction schemes and five different prediction error coders are included as individual embodiments of the present invention. The motion vector prediction schemes will be discussed first.

a) MOTION VECTOR PREDICTION SCHEMES

Prediction Scheme 1

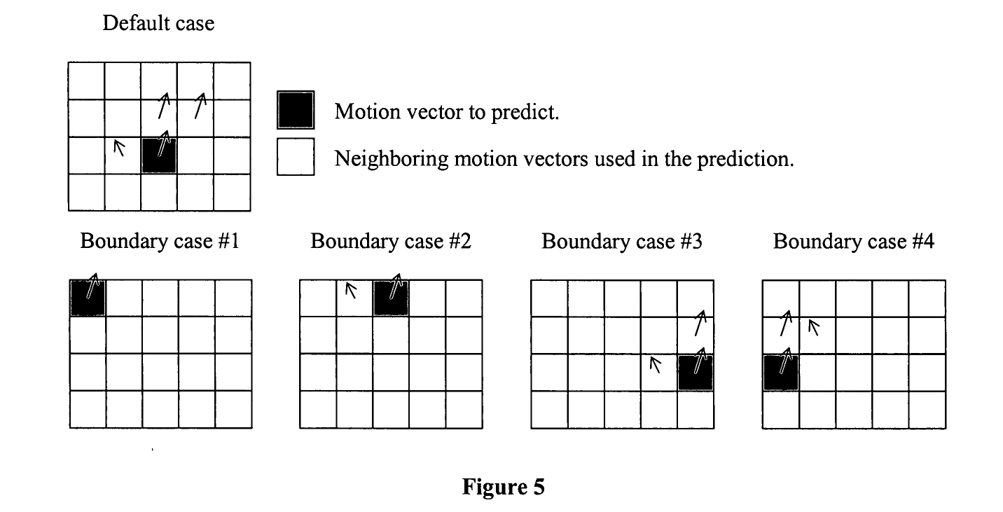

In scheme 1, the motion vectors in each subset of mvₜₒₜ (i) are predicted independently of the motion vectors in the other subsets. The prediction of the motion vectors within each subset of mvₜₒₜ (i) is performed similar to the motion vector prediction in H.263—see A. Puri and T.Chen, “Multimedia Systems, Standards, and Networks,” Marcel Dekker, 2000. Each vector is predicted by taking the median of a number of neighboring vectors. The neighboring vectors that are considered for the default case and for the particular cases that occur at boundaries are shown in FIG. 5.

Prediction Scheme 2

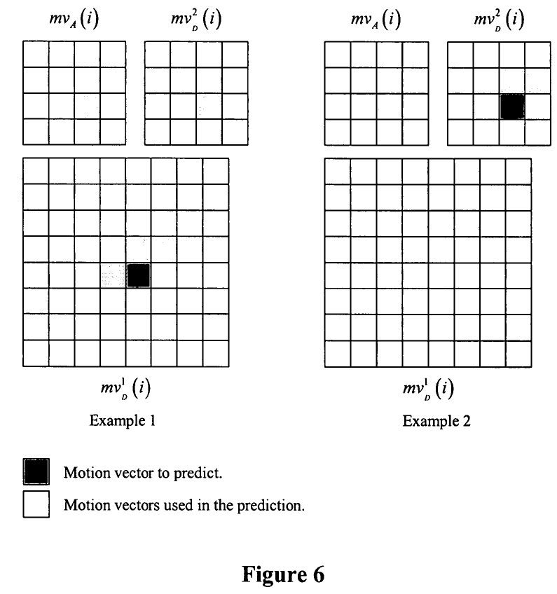

Prediction scheme 1 exploits only the spatial correlations between the neighboring motion vectors within each subset of mvₜₒₜ (i). The second prediction scheme exploits spatial correlations within the same subset as well as the correlations between corresponding motion vectors in different subsets of mvₜₒₜ (i). The prediction of a vector in a certain subset is again calculated by taking the median of a set of vectors. This set consists of a number of spatially neighboring vectors and the vectors at the equivalent position in other subsets of mvₜₒₜ (i). These other subsets are chosen based upon the wavelet decomposition level corresponding to the predicted vectors' subset. Only subsets corresponding to higher levels are considered. This is done to sustain support for resolution scalability of the motion vector data. The spatially neighboring vectors are chosen in the same way as in scheme 1 (FIG. 5). FIG. 6 illustrates the prediction scheme in the default case. The boundary cases are handled analogously to scheme 1.

Prediction Scheme 3

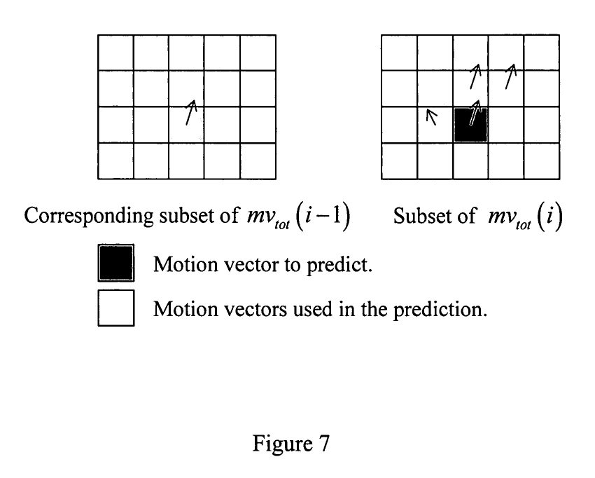

Prediction scheme 3 exploits spatial and temporal correlations between the motion vectors. The prediction of the vectors in mvₜₒₜ (i) is again performed by calculating the median of a set of vectors. This set consists of spatially neighboring vectors in the same subset of mvₜₒₜ (i) as the predicted vector, and the vector at the same position as the predicted vector in the motion vector set mvₜₒₜ (i−1). The prediction algorithm is the same for all subsets since no vectors from other subsets are involved in the prediction. The scheme is illustrated in FIG. 7 for the default case. Boundary cases are handled analogously to scheme 1.

Temporal correlations are not exploited for the first set of motion vectors generated at the beginning of a new GOP. For these motion vector sets, scheme 1 is applied.

Prediction Scheme 4

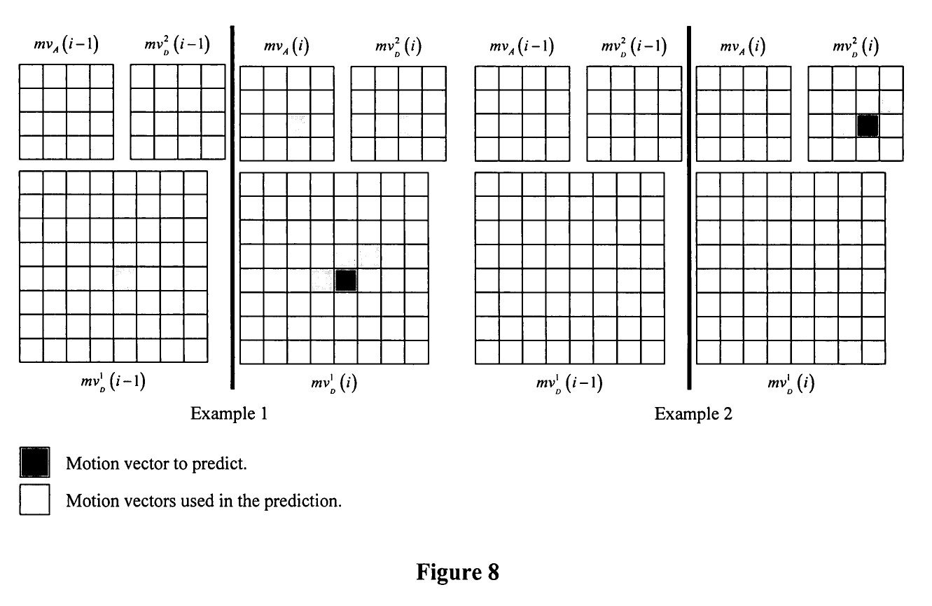

Prediction scheme 4 may be considered as a combination of schemes 2 and 3. Besides spatial correlations, both temporal and cross-subset correlations are exploited. The prediction is again calculated by taking the median of several vectors that are correlated with the predicted vector. In this case, the prediction of a vector in a subset of mvₜₒₜ (i) involves the spatially neighboring vectors in the same subset, the vector at the same position in the previous motion vector set mvₜₒₜ (i−1), and the vectors at the corresponding position in subsets associated to higher levels of decomposition. This is illustrated in FIG. 8 for the default case. Boundary cases are handled analogously to scheme 1. The prediction scheme processes the first motion vector set in each GOP in a different way than the other motion vector sets. For the prediction of these particular sets, prediction scheme 2 is used.

b) PREDICITION ERROR CODING

Next, the different prediction error coding schemes are discussed. All the presented schemes encode the prediction error components separately. Given the search ranges used in the in-band motion estimation, it can be determined that the components of the prediction error vectors are integer numbers limited to the following intervals:

TABLE 1
Range of the prediction error components.

| | |
|---|---|
| Integer pixel accuracy | [−31, 31] |
| Half-pixel accuracy | [−63, 63] |
| Quarter pixel accuracy | [−127, 127] |

This can be verified using the conversion formulas between the in-band motion vectors and their equivalent spatial domain vectors.
Prediction-Error Coder 1

This coder uses context-based arithmetic coding to encode the prediction error components. As said before, the x and y components of the prediction error are coded separately. Both components are integer numbers restricted to a bounded interval as specified in Table 1. This interval is divided into several subintervals as specified in the following table (Table 2):

TABLE 2
Division of the total range of the prediction error components.

| Integer pixel accuracy | | Half pixel accuracy | | Quarter pixel accuracy | |
|---|---|---|---|---|---|
| Interval | Index | Interval | Index | Interval | Index |
| [−31, −25] | 0 | [−63, −50] | 0 | [−127, −111] | 0 |
| [−24, −18] | 1 | [−49, −39] | 1 | [−110, −94] | 1 |
| [−17, −11] | 2 | [−38, −28] | 2 | [−93, −77] | 2 |
| [−10, −4] | 3 | [−27, −17] | 3 | [−76, −60] | 3 |
| [−3, 3] | 4 | [−16, −6] | 4 | [−59, −43] | 4 |
| [4, 10] | 5 | [−5, 5] | 5 | [−42, −26] | 5 |
| [11, 17] | 6 | [6, 16] | 6 | [−25, −9] | 6 |
| [18, 24] | 7 | [17, 27] | 7 | [−8, 8] | 7 |
| [25, 31] | 8 | [28, 38] | 8 | [9, 25] | 8 |
| | | [39, 49] | 9 | [26, 42] | 9 |
| | | [50, 63] | 10 | [43, 59] | 10 |
| | | | | [60, 76] | 11 |
| | | | | [77, 93] | 12 |
| | | | | [94, 110] | 13 |
| | | | | [111, 127] | 14 |

Each error component is coded as an interval-index (symbol), representing the interval it belongs to, followed by the component's offset relative to the lower boundary of that interval. Up to six models are defined for the adaptive arithmetic encoder. For each component x and y, one model is used to code the index of the interval and one model per unique interval size (integer-pel and quarter-pel: one model, half-pel: 2 models) is used to encode the offset relative to the interval's lower boundary.
Prediction-Error Coder 2

This coder is similar to coder 1, since it also codes the prediction error components as an index representing the interval it belongs to, followed by the component's offset within the interval. The choice of the intervals and the way the offsets are coded is similar to the way DCT coefficients are coded in the JPEG standard for still-image compression—see W. B. Pennebaker and J. L. Mitchell, JPEG still image data compression standard. New York: Van Nostrand Reinhold, 1993. Table 3 presents the intervals.

TABLE 3
Division of the total range of the prediction error components in coder 2.

| Integer pixel accuracy | | Half pixel accuracy | | Quarter pixel accuracy | |
|---|---|---|---|---|---|
| Interval/value | Index | Interval/value | Index | Interval/value | Index |
| 0 | 0 | 0 | 0 | 0 | 0 |
| {−1} ∪ {1} | 1 | {−1} ∪ {1} | 1 | {−1} ∪ {1} | 1 |
| [−3, −2] ∪ [2, 3] | 2 | [−3, −2] ∪ [2, 3] | 2 | [−3, −2] ∪ [2, 3] | 2 |
| [−7, −4] ∪ [4, 7] | 3 | [−7, −4] ∪ [4, 7] | 3 | [−7, −4] ∪ [4, 7] | 3 |
| [−15, −8] ∪ [8, 15] | 4 | [−15, −8] ∪ [8, 15] | 4 | [−15, −8] ∪ [8, 15] | 4 |
| [31, −16] ∪ [16, 31] | 5 | [31, −16] ∪ [16, 31] | 5 | [31, −16] ∪ [16, 31] | 5 |
| | | [−63, −32 ] ∪ [32, 63] | 6 | [−63, −32 ] ∪ [32, 63] | 6 |
| | | | | [−127, −64] ∪ [64, 127] | 7 |

When coding the offset of the prediction error component within the interval, a distinction is made between positive and negative components. For positive components, the value that is coded is equal to the prediction error component. For negative components, the algorithm encodes the sum of the prediction error component and the absolute value of the lower bound of the interval it belongs to. For example, a component value of −12 is coded as symbol 4 (to indicate the interval) followed by 3 (=−12+|−15|). No offset is coded for interval 0.

The interval-index and the value for the offset are coded using context-based arithmetic coding. For each component x and y, one model is used to code the interval-index. A different model is used to encode the offset values, and this is done depending on the interval. The offset value is coded differently for the intervals 0 to 4 than for intervals 5 to 7. In the first case the different offset values are directly coded as different symbols of the model. In the second case, the model only allows two symbols 0 and 1, and the offset value is coded in its binary representation.

Prediction-Error Coder 3

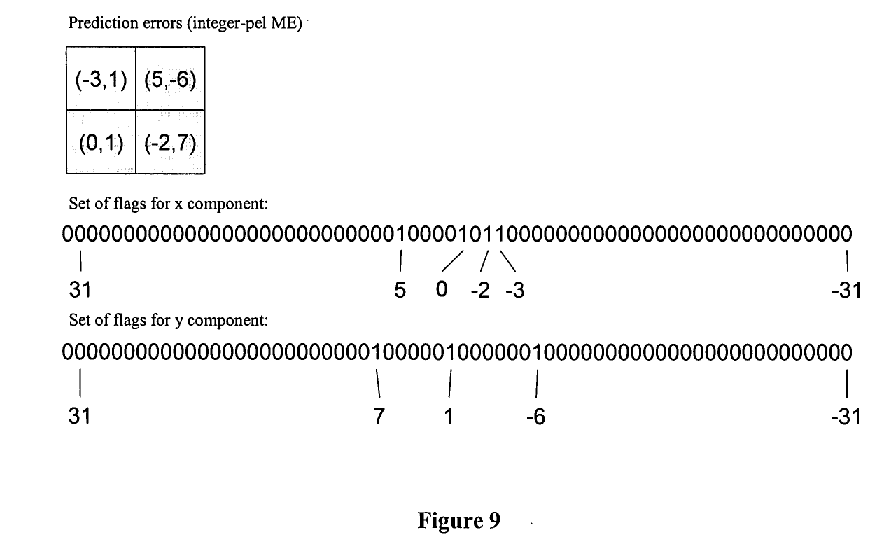

Before discussing the different prediction-error coders it has already been mentioned that in principle, the components of the prediction error can only take a limited number of different values. In a usual prediction error set, not all of the possible values occur. The occurrence of very large values is highly unlikely if the employed prediction was effective. This coder accounts for this aspect by transmitting which values do occur in the x and y components of the prediction-error set. It then constructs a lookup table for both components linking a symbol to each of the occurring values and codes the prediction error components based on this lookup tables. Two sequences of bits, one sequence for the x component of the prediction errors and one for they component indicate the values that occur in the set of prediction errors. If a value is present in the prediction error set that is going to be coded, the corresponding bit in the sequence is set to 1, otherwise it is set to 0. This is illustrated in FIG. 9.

Referring to FIG. 9 a lookup table is constructed for the x and y components, linking each value occurring in the prediction error set to a unique symbol. The lookup table is built by numbering the occurring values in a linear way, from the smallest value to the largest one. To encode a prediction error, (1) the corresponding symbols for both components x and y are found in the lookup tables, and (2) the retrieved symbols are entropy coded with an adaptive arithmetic coder that employs different models for the x and y components. The conversion to symbols obtained with this algorithm applied on the example shown in FIG. 9 is presented in Table 4.

TABLE 4

| | |
|---|---|
| x prediction- | y prediction- |
| error component | error component |

| Component | | Component | |
|---|---|---|---|
| Value | Symbol | value | Symbol |
| −3 | 0 | −6 | 0 |
| −2 | 1 | 1 | 1 |
| 0 | 2 | 7 | 2 |
| 5 | 3 | | |

Prediction-Error Coder 4

Similar to the motion vectors, the prediction errors can be split into a number of subsets corresponding to different wavelet decomposition levels and/or subbands. Each subset of the prediction errors is coded in the same way. The x and y components of the prediction errors in a subset can be considered as arrays of integer numbers. These arrays are coded using a suitable algorithm such as the quadtree-coding algorithm. The quadtree-coding algorithm entropy codes the generated symbols using adaptive arithmetic coding employing different models for the significance, refinement and sign symbols. Such a coder is inherently quality scalable as described in P. Schelkens, A. Munteanu, J. Barbarien, M. Galca, X. Giro i Nieto, and J. Cornelis, “Wavelet Coding of Volumetric Medical Datasets,” IEEE Transactions on Medical Imaging, Special issue on “Wavelets in Medical Imaging,” Editors M. Unser, A. Aldroubi, and A. Laine, vol. 22, no. 3, pp. 441-458, March 2003.

Prediction-Error Coder 5

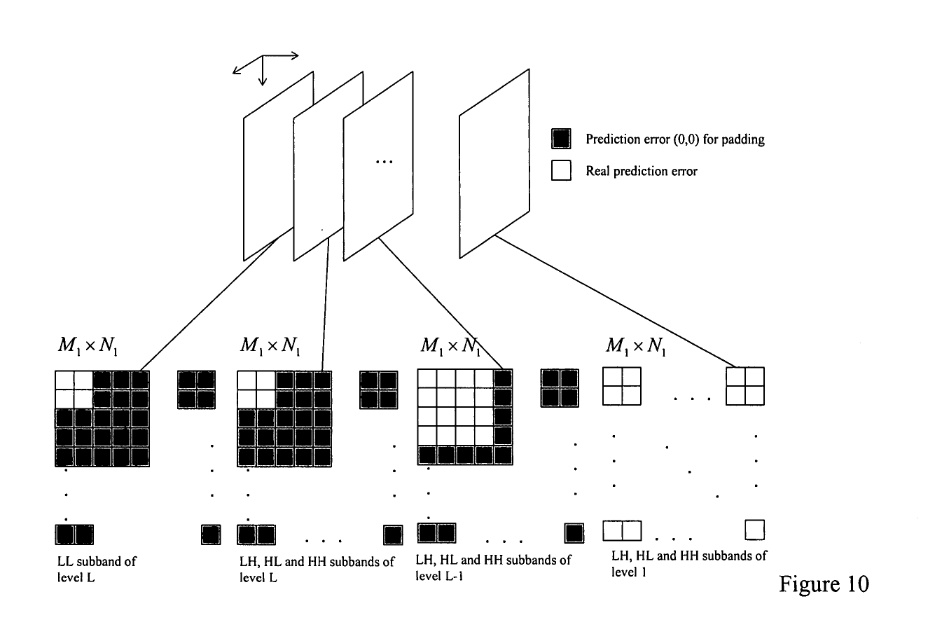

In this coding scheme, the prediction error subsets associated to the different wavelet decomposition levels, are arranged in a 3D structure as shown in FIG. 10.

This 3D structure can be split into two three-dimensional arrays of integer numbers by considering the x and y components of the prediction errors separately. These two arrays are then coded using cube splitting algorithm, combined with context-based adaptive arithmetic coding of the generated symbols. Separate sets of models are used for the x and y component arrays. The significance symbols, refinement symbols and sign symbols are entropy coded using separate models.

Motion Vector Coders Based on the Integer Wavelet Transform.

Integer Wavelet Transform

For each subset of mvₜₒₜ (i), both components of the motion vectors are transformed to the wavelet domain using the (5,3) integer wavelet transform with 2 decomposition levels. The resulting wavelet coefficients are then coded using either quadtree-based coding or cube splitting.

Quadtree Based Wavelet Coefficient Coding.

The quadtree based coding is handled in exactly the same way as in prediction error coder 4.

Wavelet Coefficient Coding using Cube Splitting

The cube splitting is handled in exactly the same way as in prediction error coder 5.

The above coders are inherently quality scalable as disclosed in the article by P. Schelkens, A. Munteanu, J. Barbarien, M. Galca, X. Giro i Nieto, and J. Cornelis, mentioned above and incorporated by reference.

Experimental Results

The proposed motion vector coding techniques have been tested on the motion vector sets generated by encoding 3 different sequences at three different quality-levels. The test sequences are listed in Table 5.

TABLE 5
Overview of the test sequences.

| Name | Resolution | Framerate | Number of frames |
|---|---|---|---|
| Football | SIF | 30 Hz | 100 |
| Mobile | CIF | 30 Hz | 256 |
| Stefan | CIF | 30 Hz | 300 |

All encoding runs were done using three wavelet decomposition levels and integer pixel accuracy of the motion estimation. The GOP (Group of picture) size was set to 16 frames.

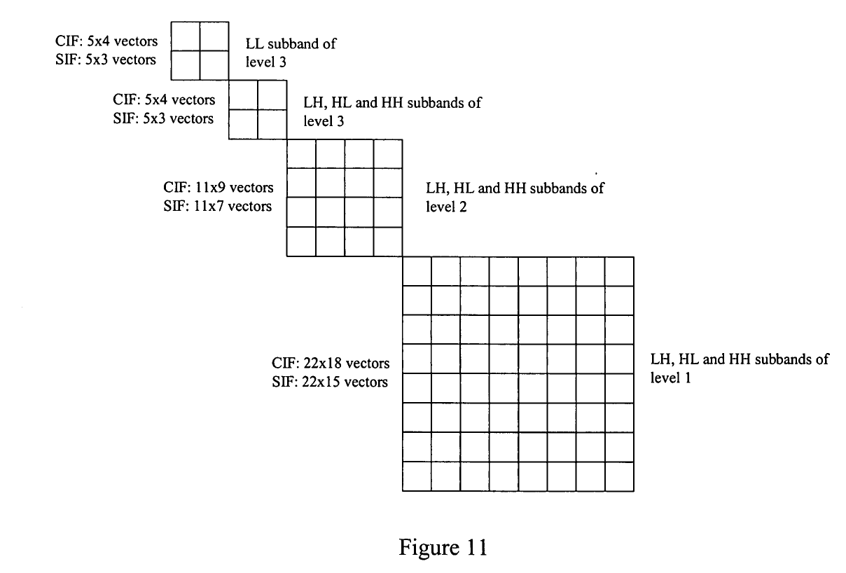

To calculate the size reductions, the uncompressed size of the motion vector data must first be determined. The structure of the generated motion vector set is shown in FIG. 11.

The bits needed to code the ODWT phase components of the in-band motion vectors for the different subsets are listed in Table 6. The amounts of bits needed to represent the offsets within the ODWT subbands are listed in Table 7.

TABLE 6
Bits needed to code the in-band motion vector's
phase components.

| | Horizontal phase i | | | Vertical phase j | | |
|---|---|---|---|---|---|---|
| | Possible | | | Possible | | |
| Subset | values | Bits needed | | values | Bits needed | |
| LL subband | [0, 7] | 3 | bits | [0, 7] | 3 | bits |
| of level 3 | | | | | | |
| LH, HL and | [0, 7] | 3 | bits | [0, 7] | 3 | bits |
| HH subband | | | | | | |
| of level 3 | | | | | | |
| LH, HL and | [0, 3] | 2 | bits | [0, 3] | 2 | bits |
| HH subband | | | | | | |
| of level 2 | | | | | | |
| LH, HL and | [0, 1] | 1 | bit | [0, 1] | 1 | bit |
| HH subband | | | | | | |
| of level 1 | | | | | | |

TABLE 7
Bits needed to code the offset components of the
in-band motion vectors.

| | Horizontal offset x | | | Vertical offset y | | |
|---|---|---|---|---|---|---|
| | Possible | | | Possible | | |
| Subset | values | Bits needed | | values | Bits needed | |
| LL subband | [−2, 1] | 2 | bits | [−2, 1] | 2 | bits |
| of level 3 | | | | | | |
| LH, HL and | [−2, 1] | 2 | bits | [−2, 1] | 2 | bits |
| HH subband | | | | | | |
| of level 3 | | | | | | |
| LH, HL and | [−4, 3] | 3 | bits | [−4, 3] | 3 | bits |
| HH subband | | | | | | |
| of level 2 | | | | | | |
| LH, HL and | [−8, 7] | 4 | bit | [−8, 7] | 4 | bit |
| HH subband | | | | | | |
| of level 1 | | | | | | |

From the two previous tables, it can be derived that the total number of bits needed to represent an in-band motion vector is always equal to 10 irrespective of the subset the motion vector is part of. Together with the information of the structure of the motion vector set (as given in FIG. 11), the total uncompressed size of one motion vector set can be calculated. For CIF sequences the number of bits spent per frame equals:
(2·(5·4)+(11·9)+(22·18))·10 bits=5350 bits=668.75 bytes
For SIF sequences the uncompressed size is given by:
(2·(5·3)+(11·7)+(22·15))·10 bits=4370 bits=546.25 bytes
The results of the experiments are given in the following tables. The reported numbers are the average size reductions in % obtained with respect to the uncompressed size.

Results for the Coders Based on Motion-Vector Prediction and Prediction-Error Coding.

TABLE 8
Results for the “Football” sequence.

| Technique | | Average PSNR of the decoded frames | | |
|---|---|---|---|---|
| Motion | | 26.1 dB | | |
| vector | Prediction error | % | 29.3 dB | 40.3 dB |
| predictor | coder | reduction | % reduction | % reduction |
| 1 | 1 | 3.7 | 17.2 | 28.7 |
| 2 | 1 | 4.3 | 14.1 | 23.5 |
| 3 | 1 | 6.1 | 19.2 | 30.9 |
| 4 | 1 | 8.0 | 20.2 | 31.0 |
| 1 | 2 | 5.8 | 21.0 | 33.5 |
| 2 | 2 | 5.7 | 17.3 | 28.0 |
| 3 | 2 | 7.7 | 22.4 | 34.9 |
| 4 | 2 | 9.7 | 23.4 | 35.3 |
| 1 | 3 | 3.4 | 18.1 | 30.0 |
| 2 | 3 | 4.2 | 15.2 | 25.2 |
| 3 | 3 | 5.2 | 19.3 | 31.3 |
| 4 | 3 | 7.9 | 21.0 | 32.1 |
| 1 | 4 | 2.1 | 18.8 | 32.5 |
| 2 | 4 | 1.8 | 15.5 | 27.6 |
| 3 | 4 | 3.5 | 20.1 | 33.9 |
| 4 | 4 | 5.1 | 20.7 | 33.9 |
| 1 | 5 | −4.0 | 13.6 | 27.8 |
| 2 | 5 | −4.5 | 9.9 | 22.5 |
| 3 | 5 | −2.4 | 15.0 | 29.4 |
| 4 | 5 | −0.7 | 15.8 | 29.5 |

TABLE 9
Results for the “Mobile” sequence.

| Technique | | Average PSNR of the decoded frames | | |
|---|---|---|---|---|
| Motion | | 26.4 | | |
| vector | Prediction error | dB | 29.6 dB | 40.2 dB |
| predictor | coder | % reduction | % reduction | % reduction |
| 1 | 1 | 54.4 | 62.7 | 71.2 |
| 2 | 1 | 50.0 | 56.3 | 61.8 |
| 3 | 1 | 54.8 | 63.8 | 73.1 |
| 4 | 1 | 56.2 | 63.5 | 71.0 |
| 1 | 2 | 58.4 | 66.4 | 74.5 |
| 2 | 2 | 54.8 | 61.1 | 66.6 |
| 3 | 2 | 58.5 | 67.2 | 76.2 |
| 4 | 2 | 59.9 | 67.0 | 74.1 |
| 1 | 3 | 55.1 | 63.2 | 71.6 |
| 2 | 3 | 51.9 | 58.2 | 64.0 |
| 3 | 3 | 55.2 | 63.9 | 73.2 |
| 4 | 3 | 56.9 | 64.0 | 71.4 |
| 1 | 4 | 55.7 | 64.4 | 73.4 |
| 2 | 4 | 50.5 | 57.3 | 63.6 |
| 3 | 4 | 56.2 | 65.3 | 75.0 |
| 4 | 4 | 55.6 | 63.2 | 71.0 |
| 1 | 5 | 53.4 | 62.3 | 71.7 |
| 2 | 5 | 47.9 | 54.9 | 61.4 |
| 3 | 5 | 53.8 | 63.2 | 73.3 |
| 4 | 5 | 53.4 | 61.2 | 69.3 |

TABLE 10
Results for the “Stefan” sequence.

| Technique | | Average PSNR of the decoded frames | | |
|---|---|---|---|---|
| Motion | | 26.2 | | |
| vector | Prediction error | dB | 29.1 dB | 40.0 dB |
| predictor | coder | % reduction | % reduction | % reduction |
| 1 | 1 | 13.4 | 21.9 | 32.9 |
| 2 | 1 | 14.3 | 20.3 | 28.4 |
| 3 | 1 | 14.5 | 22.9 | 33.9 |
| 4 | 1 | 16.9 | 24.0 | 33.2 |
| 1 | 2 | 17.2 | 26.3 | 37.4 |
| 2 | 2 | 17.4 | 24.3 | 33.2 |
| 3 | 2 | 17.2 | 26.3 | 37.8 |
| 4 | 2 | 20.2 | 27.8 | 37.5 |
| 1 | 3 | 14.9 | 23.7 | 34.3 |
| 2 | 3 | 16.0 | 22.4 | 30.8 |
| 3 | 3 | 14.9 | 23.6 | 34.8 |
| 4 | 3 | 18.6 | 25.8 | 34.9 |
| 1 | 4 | 14.4 | 24.7 | 36.5 |
| 2 | 4 | 13.4 | 21.3 | 30.6 |
| 3 | 4 | 14.4 | 24.6 | 36.7 |
| 4 | 4 | 15.9 | 24.8 | 35.0 |
| 1 | 5 | 10.6 | 21.1 | 33.3 |
| 2 | 5 | 9.4 | 17.4 | 27.0 |
| 3 | 5 | 10.5 | 21.0 | 33.5 |
| 4 | 5 | 12.2 | 21.2 | 31.8 |

Results for the Coders Based on the Integer Wavelet Transform.

TABLE 11
Results for the “Football” sequence.

| Technique | Average PSNR of the decoded frames | | |
|---|---|---|---|
| Wavelet coefficient coding | 26.1 dB | 29.3 dB | 40.3 dB |
| technique | % reduction | % reduction | % reduction |
| Quadtree coding | −5.7 | 3.9 | 12.9 |
| Cube splitting | −13.6 | −3.2 | 6.4 |

TABLE 12
Results for the “Mobile” sequence.

| Technique | Average PSNR of the decoded frames | | |
|---|---|---|---|
| Wavelet coefficient coding | 26.4 dB | 29.6 dB | 40.2 dB |
| technique | % reduction | % reduction | % reduction |
| Quadtree coding | 31.1 | 31.1 | 41.0 |
| Cube splitting | 27.4 | 27.4 | 37.8 |

TABLE 13
Results for the “Stefan” sequence.

| Technique | Average PSNR of the decoded frames | | |
|---|---|---|---|
| Wavelet coefficient coding | 26.2 dB | 29.1 dB | 40.0 dB |
| technique | % reduction | % reduction | % reduction |
| Quadtree coding | 1.8 | 9.1 | 18.8 |
| Cube splitting | −3.3 | 4.3 | 14.4 |

Several conclusions can be derived from these results. Firstly, the correlation between the motion vectors seems to decrease as the quality of the decoded frames decreases. The diminished motion estimation effectiveness probably causes the motion vectors to drift further away from the real motion field, which usually consists of highly correlated motion vectors. The second conclusion is that the motion vector coding techniques based on the integer wavelet transform perform worse than any of the techniques based on predictive coding. The best of the prediction-based coders seem to be:
(1) the algorithm based upon the spatio-temporal prediction scheme (scheme 3) and prediction-error coder 2, and
(2) the algorithm based on the spatio-temporal-cross-subset prediction scheme (scheme 4) and prediction-error coder 2.
   Which of the two predictors performs the best depends on the sequence and on the quality of the decoded frames.
   Drift-free Prediction-based Quality and Resolution Scalable Motion Vector Coding

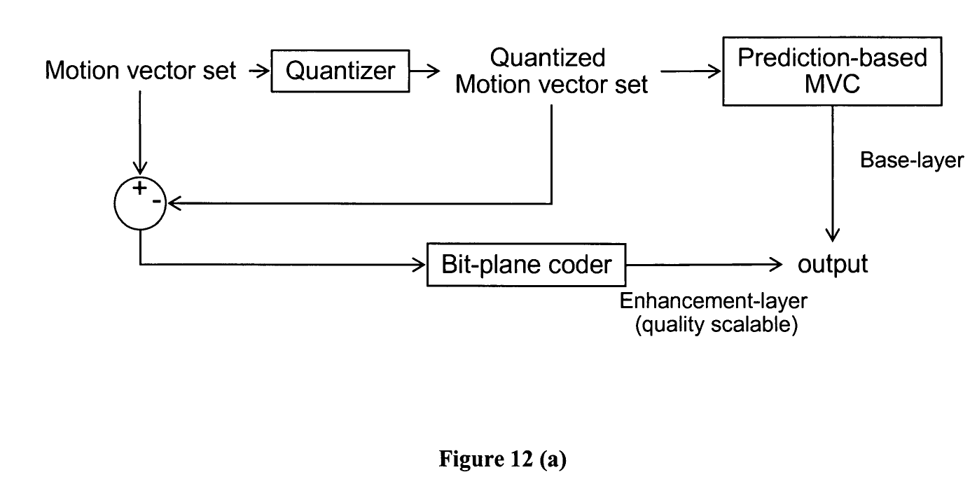

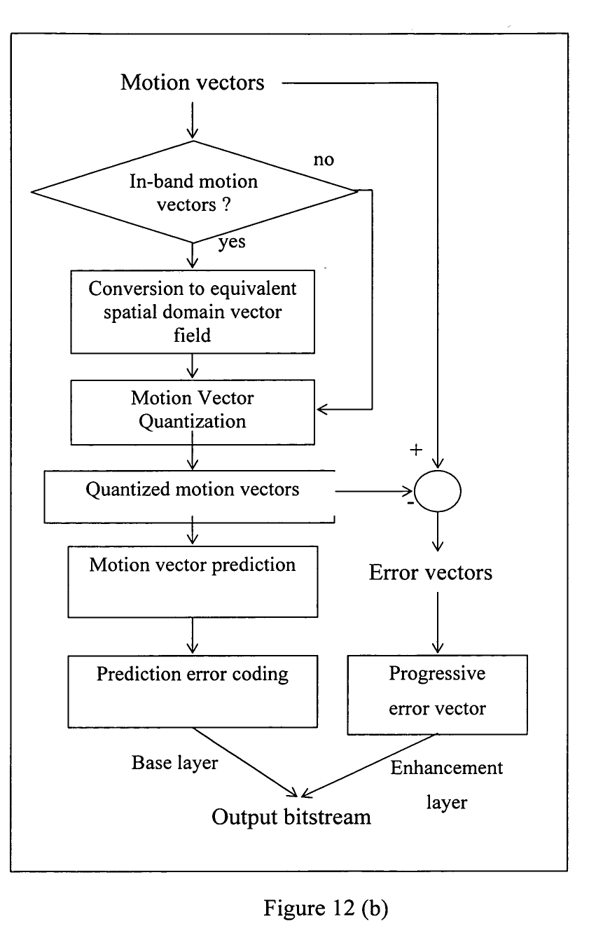

In further embodiments of the present invention the problem of drift is solved by a motion vector coding architecture in accordance with a further embodiment of the present invention. The general setup is shown in FIG. 12a which is a coder which can use the flow diagram of FIG. 12b.

With reference to FIGS. 12a and b a spatial or in-band set of motion vectors is obtained by motion estimation. These are quantized to generate a quantized set of motion vectors. If the motion vectors are in-band they are converted to their equivalent motion vectors in the spatial domain as described with reference to FIG. 4a. The quantized motion vectors are subjected to motion vector prediction by any of the methods described with reference to FIG. 4a as described above. These quantized motion vectors are then coded in accordance with any of the prediction-based motion vector coding methods described above to form a base layer set of quantized motion vectors. In the receiver the decoding of the base layer follows as described with respect to the embodiments above. One or more new sets of motion vectors are created in accordance with this embodiment to form one or more enhancement layers of motion vectors. This is achieved by generating error vectors by finding the difference between each quantized motion vector and its equivalent input motion vector from which it was derived. These error vectors are then subjected to a progressive compression to form one or more quality scalable enhancement layers. Each error vector is a difference between a motion vector and its quantized equivalent, and each error vector is compressed using a progressive entropy coder. The progressive entropy encoder can be a lossy-to-lossless binary entropy encoder. The base layer set and the set or sets of the one or more enhancement layer coded motion vectors are then combined to form the bit stream to be transmitted. Decoding follows by the reverse procedure.

In accordance with an embodiment of the present invention, the quantization of the input motion vector set can be performed, e.g. by dropping the information on the lowest bit-plane(s). The quantized motion vectors are thereafter compressed using a prediction-based motion vector coding technique, e.g. one of the techniques described in J. Barbarien, I. Andreopoulos, A. Munteanu, P. Schelkens, and J. Cornelis, “Coding of motion vectors produced by wavelet-domain motion estimation,” ISO/IEC JTC1/SC29/WG11 (MPEG), Awaji island, Japan, m9249, December 2002 or any of the prediction-based motion vector coding technique described above with respect to the previous embodiments. The resulting compressed data forms the base-layer of the final bit-stream. To avoid drift, this base-layer is preferably always decoded losslessly. Then the quantization error (the difference between the quantized motion vectors and the original motion vectors) is coded in a bit-plane-by-bit-plane manner using a binary entropy coder or a bit-plane coding algorithm supporting quality scalability, e.g. EBCOT described in D. Taubman and M. W. Marcellin, “JPEG2000—Image Compression: Fundamentals, Standards and Practice,” Hingham, MA: Kluwer Academic Publishers, 2001, or QT-L described in P. Schelkens, A. Munteanu, J. Barbarien, M. Galca, X. Giro i Nieto, and J. Cornelis, “Wavelet Coding of Volumetric Medical Datasets,” IEEE Transactions on Medical Imaging, Special issue on “Wavelets in Medical Imaging,” Editors M. Unser, A. Aldroubi, and A. Laine, vol. 22, no. 3, pp. 441-458, March 2003. The compressed data forms the enhancement layer(s) of the final bit-stream. The quality and bit-rate of this layer can be varied without introducing drift. In this way, the final bit-stream supports fine-grain quality scalability with a bit-rate that can vary between the bit-rate needed to code the base-layer losslessly and the bit-rate needed for a completely lossless reconstruction of the motion vectors. The bit-rate needed to code the base-layer can be controlled in the encoder by choosing an appropriate quantizer. Choosing a lower bit-rate for the base-layer will however decrease the overall coding efficiency of the entire scheme.

Implementation

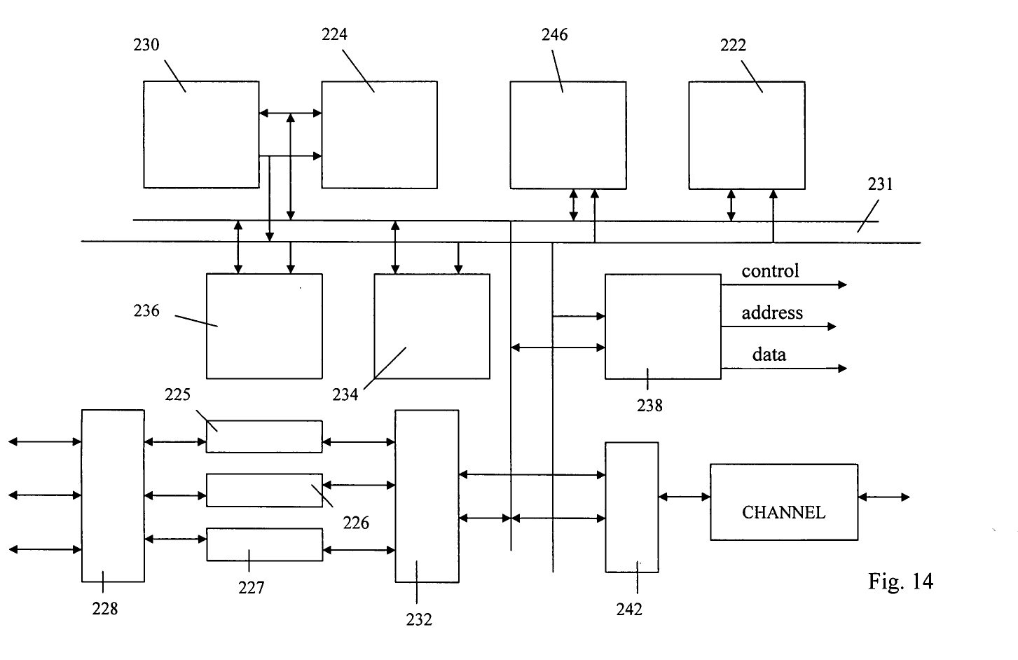

FIG. 14 shows the implementation of a coder/decoder which can be used with any of the embodiments of the present invention implemented using a microprocessor 230 such as a Pentium IV from Intel Corp. USA. The microprocessor 230 may have an optional element such as a co-processor 224, e.g. for arithmetic operations or microprocessor 230-224 may be a bit-sliced processor. A RAM memory 222 may be provided, e.g. DRAM. Various I/O (input/output) interfaces 225, 226, 227 may be provided, e.g. UART, USB, I²C bus interface as well as an I/O selector 228. FIFO buffers 232 may be used to decouple the processor 230 from data transfer through these interfaces. A keyboard and mouse interface 234 will usually be provided as well as a visual display unit interface 236. Access to an external memory such as a disk drive may be provided via an external bus interface 238 with address, data and control busses. The various blocks of the circuit are linked by suitable busses 231. The interface to the channel is provided by block 242 which can handle the encoded video frames as well as transmitting to and receiving from the channel. Encoded data received by block 242 is passed to the processor 230 for processing.

Alternatively, this circuit may be constructed as a VLSI chip around an embedded microprocessor 230 such as an ARM7TDMI core designed by ARM Ltd., UK which may be synthesized onto a single chip with the other components shown. A zero wait state SRAM memory 222 may be provided on-chip as well as a cache memory 224. Various I/O (input/output) interfaces 225, 226, 227 may be provided, e.g. UART, USB, I²C bus interface as well as an I/O selector 228. FIFO buffers 232 may be used to decouple the processor 230 from data transfer through these interfaces. A counter/timer block 234 may be provided as well as an interrupt controller 236. Access to an external memory may be provided an external bus interface 238 with address, data and control busses. The various blocks of the circuit are linked by suitable busses 231. The interface to the channel is provided by block 242 which can handle the encoded video frames as well as transmitting to and receiving from the channel. Encoded data received by block 242 is passed to the processor 230 for processing.

Software programs may be stored in an internal ROM (read only memory) 246 which may include software programs for carrying out decoding and/or encoding in accordance with any of the methods of the present invention including motion vector coding or decoding in accordance with any of the methods of the present invention. The methods described above may be written as computer programs in a suitable computer language such as C and then compiled for the specific processor in the design. For example, for the embedded ARM core VLSI described above the software may be written in C and then compiled using the ARM C compiler and the ARM assembler. Reference is made to “ARM System-on-chip”, S. Furber, Addison-Wiley, 2000. The present invention also includes a data carrier on which is stored executable code segments, which when executed on a processor such as 230 will execute any of the methods of the present invention, in particular will execute any of the motion vector coding or decoding methods of the present invention. The data carrier may be any suitable data carrier such as diskettes (“floopy disks”), optical storage media such as CD-ROMs, DVD ROM's, tape drives, hard drives, etc. which are computer readable.

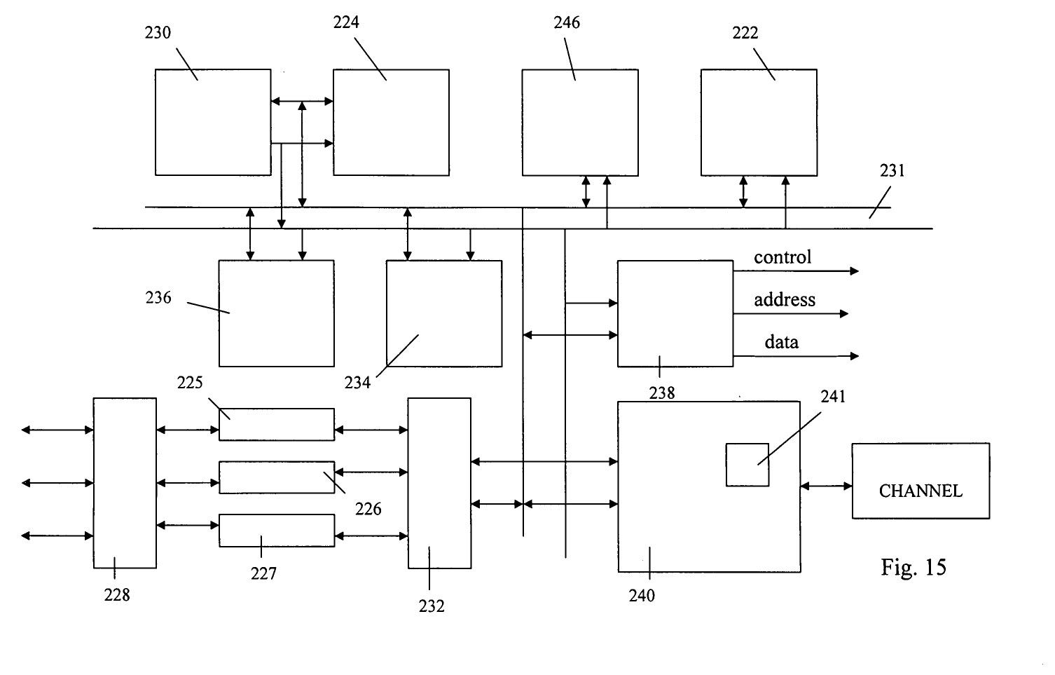

FIG. 15 shows the implementation of a coder/decoder which can be used with the present invention implemented using a dedicated motion vector coding module. Reference numbers in FIG. 15 which are the same as the reference numbers in FIG. 14 refer to the same components—both in the microprocessor and the embedded core embodiments.

Only the major differences of FIG. 15 will be described with respect to FIG. 14. Instead of the microprocessor 230 carrying out methods required to provide motion vector compression of a bitstream this work is now taken over by a module 240. Module 240 may be constructed as an accelerator card for insertion in a personal computer. The module 240 has means for carrying out motion vector decoding and/or encoding in accordance with any of the methods of the present invention. These motion vector coding means may be implemented as a separate module 241, e.g. an ASIC (Application Specific Integrated Circuit) or an FPGA (Field Programmable Gate Array) having means for motion vector compression according to any of the embodiments of the present invention described above.

Similarly, if an embedded core is used such as an ARM processor core or an FPGA, a module 240 may be used which may be constructed as a separate module in a multi-chip module (MCM), for example or combined with the other elements of the circuit on a VLSI. The module 240 has means for carrying out motion vector decoding and/or encoding in accordance with any of the methods of the present invention. As above, these means for motion vector coding or decoding may be implemented as a separate module 241, e.g. an ASIC (Application Specific Integrated Circuit) or an FPGA (Field Programmable Gate Array) having means for motion vector encoding or decoding according to any of the embodiments of the present invention described above. The present invention also includes other integrated circuits such as ASIC's or FPGA's which carry out such functions.

While the above detailed description has shown, described, and pointed out novel features of the invention as applied to various embodiments, it will be understood that various omissions, substitutions, and changes in the form and details of the device or process illustrated may be made by those skilled in the art without departing from the intent of the invention. The scope of the invention is indicated by the appended claims rather than by the foregoing description. All changes that come within the meaning and range of equivalency of the claims are to be embraced within their scope.

What is claimed is:

1. A method of coding motion information in a stream of image frames, comprising:
providing a set of motion vectors for at least one image frame;
quantizing the motion vectors so as to generate a set of quantized motion vectors equivalent to the motion vectors;
compressing the quantized motion vectors losslessly;
generating a set of error vectors, each being based on a difference between a motion vector and its quantized equivalent; and
progressively encoding the error vectors in a lossy-to-lossless manner.

2. The method of claim 1, wherein the coding is drift free.

3. The method of claim 1, wherein the compression is based on a prediction.

4. The method according to claim 1, wherein the motion vectors are resolution scalable.

5. The method of claim 1, wherein the motion vectors are in-band motion vectors.

6. The method according to claim 1, wherein motion vector quality is scalable.

7. The method according to claim 1, wherein the coding is temporally scalable.

8. The method according to claim 1, wherein each error vector is a difference between a motion vector and its quantized equivalent, and each error vector is compressed using a progressive entropy coder.

9. The method according to claim 8, wherein the progressive entropy encoder is a lossy-to-lossless binary entropy encoder.

10. The method according to claim 1, wherein the compression of the quantized motion vectors is based on motion-vector prediction and prediction-error coding.

11. The method according to claim 10, wherein the prediction error vectors are the difference between the quantized motion vectors and their predicted equivalent.

12. The method according to claim 1, wherein the prediction of the quantized motion vectors is non-linear.

13. The method according to claim 12, wherein the non-linear prediction includes determining a median.

14. The method according to claim 1, wherein the compression of the prediction-error vectors is based on reducing the alphabet prior to entropy coding.

15. The method according to claim 1, wherein the compression of the prediction-error vectors is done by prior classification.

16. A method of decoding encoded motion vectors in a bitstream received at a receiver having been encoded by the method of claim 1, the method comprising progressively decoding the error vectors in a lossy-to-lossless manner.

17. The method according to claim 16, further comprising determining quantized motion vectors from received data in the bitstream and reconstructing motion vectors from the quantized motion vectors and the decoded error vectors.

18. The method of claim 17, further comprising predicting the quantized motion vectors from received data in the bitstream.

19. The method according to claim 17, further comprising motion compensating decoded frame data retrieved from the bitstream using the reconstructed motion vectors.

20. A method of providing a representation of motion information in a stream of image frames, comprising:
providing a set of in-band motion vectors of at least one image frame;
converting the in-band motion vectors to a spatial domain to generate a set of motion vectors equivalent to the in-band motion vectors;
transforming the motion vectors in the spatial domain to a wavelet domain using an integer wavelet transform so as to generate wavelet coefficients; and
coding the wavelet coefficients.

21. The method of claim 20 wherein the coding of the wavelet coefficients is based on quadtree coding or cube splitting.

22. The method according to claim 20, wherein the resolution is scalable.

23. The method according to claim 20, wherein the coding is temporally scalable.

24. The method according to claim 20, wherein the motion vector quality is scalable.

25. A method of decoding a bitstream received at a receiver which has been coded by a method according to claim 20, the method comprising decoding the wavelet coefficients and generating the motion vectors.

26. A method of coding motion vectors of at least one image frame in a stream of image frames, comprising:
transforming the motion vectors using the integer wavelet transform so as to generate wavelet coefficients; and
coding the wavelet coefficients.

27. The method according to claim 26, wherein the motion vectors are in-band.

28. The method according to claim 26, further comprising converting the in-band motion vectors to their spatial-domain equivalents.

29. The method according to claim 26, further comprising transforming the motion vectors using the integer wavelet transform so as to generate wavelet coefficients.

30. The method according to claim 26, further comprising coding the wavelet coefficients based on quadtree coding or cube splitting respectively.

31. The method according to claim 26, wherein the resolution is scalable.

32. The method according to claim 26, wherein the coding is temporally scalable.

33. The method according to claim 26, wherein the motion vectors are quality scalable.

34. A method of decoding a bitstream received at a receiver which has been coded by a method according to claim 26, the method comprising decoding the wavelet coefficients and generating motion vectors from the decoded wavelet coefficients.

35. An encoder for coding motion information in a stream of image frames, comprising:
means for providing motion vectors for at least one image frame;
means for quantizing the motion vectors so as to generate a set of quantized motion vectors equivalent to the motion vectors;
means for compressing the quantized motion vectors losslessly;
means for generating error vectors, each error vector being a difference between a motion vector and its quantized equivalent; and
means for progressively encoding the error vectors in a lossy-to-lossless manner.

36. The encoder of claim 35 wherein the coding is drift free.

37. The encoder of claim 35, wherein the means for compressing includes means for predicting.

38. The encoder according to claim 35, wherein the means for generating error vector determines a difference between a motion vector and its quantized equivalent, and further comprising a progressive entropy coder for compressing each error vector.

39. The encoder according to claim 38, wherein the progressive entropy encoder is a lossy-to-lossless binary entropy encoder.

40. The encoder according to claim 35, wherein the means for compressing the quantized motion vectors includes means for predicting motion-vector and for prediction-error coding.

41. The encoder according to claim 40, wherein the means for prediction error coding determines error vectors from the difference between the quantized motion vectors and their predicted equivalent.

42. The encoder according to claim 35, wherein the means for prediction of the quantized motion vectors is a non-linear prediction means.

43. The encoder according to claim 35, wherein the means for compression of the prediction-error vectors includes means for reducing the alphabet prior to entropy coding.

44. The encoder according to claim 35, wherein the means for compression of the prediction-error vectors includes means for prior classification.

45. A decoder for decoding encoded motion vectors in a bitstream received at the decoder having been encoded by the method of claim 1, the decoder comprising means for progressively decoding the error vectors in a lossy-to-lossless manner.

46. The decoder according to claim 45, further comprising means for determining quantized motion vectors from received data in the bitstream and means for reconstructing motion vectors from the quantized motion vectors and the decoded error vectors.

47. The decoder of claim 46, further comprising means for predicting the quantized motion vectors from received data in the bitstream.

48. The decoder according to claim 46, further comprising means for motion compensating decoded frame data retrieved from the bitstream using the reconstructed motion vectors.

49. A device for providing a representation of motion information in a stream of image frames, comprising:
means for providing in-band motion vectors of at least one image frame;
means for converting the in-band motion vectors to a spatial domain so as to generate motion vectors equivalent to the in-band motion vectors;
means for transforming the motion vectors in the spatial domain to a wavelet domain using an integer wavelet transform to generate wavelet coefficients; and
means for coding the wavelet coefficients.

50. The device of claim 49, wherein the means for coding the wavelet coefficients includes means for quadtree coding or cube splitting.

51. A decoder for decoding a bitstream received at the decoder which has been coded by a method according to claim 49, the decoder comprising means for decoding the wavelet coefficients and means for generating the motion vectors.

52. An encoder for coding motion vectors of at least one image frame in a stream of image frames, comprising:
means for transforming the motion vectors using the integer wavelet transform to generate wavelet coefficients; and
means for coding the wavelet coefficients.

53. The encoder according to claim 52, wherein the motion vectors are in-band, further comprising means for converting the in-band motion vectors to their spatial-domain equivalents.

54. The encoder according to claim 52, further comprising means for transforming the motion vectors using the integer wavelet transform to generate wavelet coefficients.

55. The encoder according to claim 52, further comprising means for coding of the wavelet coefficients using 2D or 3D techniques preferably based on quadtree coding or cube splitting respectively.

56. A decoder for decoding a bitstream received at the decoder which has been coded by the encoder according to claim 52, the decoder comprising means for decoding the wavelet coefficients and means for generating the motion vectors from the decoded wavelet coefficients.

57. A coder, comprising:
a processor receiving a plurality of motion vectors associated with at least one image frame in a stream of image frames; and
software executed by the processor which transforms the motion vectors using an integer wavelet transform so as to generate wavelet coefficients, and which codes the wavelet coefficients.

58. The coder of claim 57, further comprising a decoder to decode the coded information.
